(19) United States
(12) Patent Application Publication
(10) Pub. No.: US 2025/0148697 A1
(43) Pub. Date: May 8, 2025

(54) PHOTOREALISTIC TRAINING DATA AUGMENTATION

(71) Applicant: NEC Laboratories America, Inc., Princeton, NJ (US)

(72) Inventors: Ziyu Jiang, Sunnyvale, CA (US); Bingbing Zhuang, Santa Clara, CA (US); Manmohan Chandraker, Santa Clara, CA (US)

(21) Appl. No.: 18/936,290

(22) Filed: Nov. 4, 2024

Related U.S. Application Data
(60) Provisional application No. 63/596,733, filed on Nov. 7, 2023.

(51) Int. Cl. G06T 15/08

(52) U.S. Cl. CPC G06T 15/08

(57) ABSTRACT

Methods and systems include training a model for rendering a three-dimensional volume using a loss function that includes a depth loss term and a distribution loss term that regularize an output of the model to produce realistic scenarios. A simulated scenario is generated based on an original scenario, with the simulated scenario including a different position and pose relative to the original scenario in a three-dimensional (3D) scene that is generated by the model from the original scenario. A self-driving model is trained for an autonomous vehicle using the simulated scenario.

### RELATED APPLICATION INFORMATION

This application claims priority to U.S. Patent Application No. 63/596,733, filed on Nov. 7, 2023, incorporated herein by reference in its entirety.

### BACKGROUND

### Technical Field

The present invention relates to training a machine learning model and, more particularly, to data augmentation.

### Description of the Related Art

Visual machine learning models are trained on example images from a target environment. The efficacy of these models increases with the number of training example images. However, it can be difficult to obtain suitable training examples that represent all realistic scenarios, particularly in environments where certain events are rare but significant.

### SUMMARY

A method includes training a model for rendering a three-dimensional volume using a loss function that includes a depth loss term and a distribution loss term that regularize an output of the model to produce realistic scenarios. A simulated scenario is generated based on an original scenario, with the simulated scenario including a different position and pose relative to the original scenario in a three-dimensional (3D) scene that is generated by the model from the original scenario. A self-driving model is trained for an autonomous vehicle using the simulated scenario.

A system includes a hardware processor and a memory that stores a computer program. When executed by the hardware processor, the computer program causes the hardware processor to train a model for rendering a three-dimensional volume using a loss function that includes a depth loss term and a distribution loss term that regularize an output of the model to produce realistic scenarios, to generate a simulated scenario based on an original scenario, with the simulated scenario including a different position and pose relative to the original scenario in a 3D scene that is generated by the model from the original scenario, and to train a self-driving model for an autonomous vehicle using the simulated scenario.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing an exemplary road scene for an autonomous vehicle, in accordance with an embodiment of the present invention;

FIG. 2 is a block/flow diagram of a method for generating and using simulated scenarios in the training and use of a self-driving model for an autonomous vehicle, in accordance with an embodiment of the present invention;

FIG. 3 is a diagram of an autonomous vehicle with a trained model that selects driving actions in response to driving conditions, in accordance with an embodiment of the present invention;

FIG. 4 is a block diagram of a computing device that can train a neural radiance field (NeRF) model to simulate realistic driving scenarios, in accordance with an embodiment of the present invention;

FIG. 5 is a diagram of an exemplary neural network architecture that can be used as part of a NeRF model, in accordance with an embodiment of the present invention; and

FIG. 6 is a diagram of an exemplary deep neural network architecture that can be used as part of a NeRF model, in accordance with an embodiment of the present invention.

### DETAILED DESCRIPTION OF PREFERRED EMBODIMENTS

Photorealistic sensor data can be simulated in varying positions, orientations, and maneuvers based on original sensor data from a training dataset. This simulated sensor data can then be used to further train and improve a visual machine learning model for use in, e.g., an autonomous vehicle. A neural radiance field (NeRF) can be used with a depth regularization loss to eliminate the ambiguity of an RGB (red-green-blue) loss and to encourage the model to learn correct geometry information. Criteria are further used to ensure the photorealism of the simulated data.

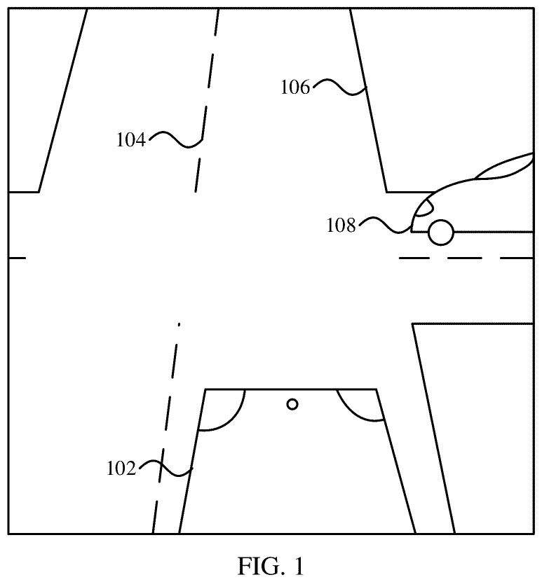

Referring now to FIG. 1, an example scene is shown. The scene may be captured by a camera that is mounted on a vehicle 102, and may show the surroundings of the vehicle 102 from a particular perspective. It should be understood that multiple such images may be used to show various perspectives, to ensure awareness of the vehicle's entire surroundings. In some cases, a panoramic or 360° camera may be used. In some cases the scene information may include depth information, such as is generated by a light detection and ranging (LiDAR) sensor.

The scene may show a variety of objects. For example, the scene may include environmental features, such as the road boundary 106 and lane markings 104, as well as moving objects, such as other vehicles 108. Other objects, such as pedestrians, animals, road obstructions, road hazards, street lights, and barriers may also be included.

Scenes such as this one are used to train a model to operate an autonomous vehicle 102. A series of images of the scene may be taken together to teach the model how a typical scene may involve and may be used for object detection, object tracking, and path prediction.

Some scenes may depict events with high consequences. For example, if another vehicle 108 is shown drifting out of its lane, this poses a potential hazard for the autonomous vehicle 102. Failing to respond in an appropriate fashion to such an event can increase the risk of injury and property damage. However, such events are relatively uncommon as compared to the great volume of normal, low-stakes scenarios.

It is therefore helpful to generate simulated scenarios which can be used to train the model, without relying on uncommon real-world events. While simulated scenarios may be generated manually, with assets like buildings, trees, roads, and pedestrians, such approaches involve a high level of human effort and can often produce simulations which are not photorealistic and which may, therefore, be less effective in training a model to handle real-world data. NeRF can be used to transfer real driving videos into a three-dimensional (3D) volume, which can be used to then simulate new scenarios by changing positions and perspectives within that volume. The NeRF model thus renders a 3D volume based on a 2D input. Depth regularization helps to ensure that the NeRF-simulated example handles novel views that are distant from the original camera trajectory.

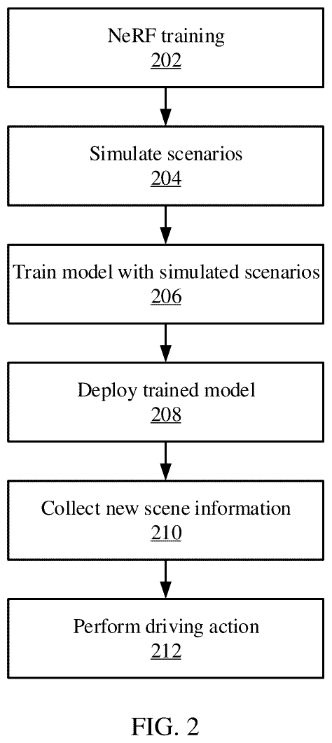

Referring now to FIG. 2, a method of generating and using simulated training data for an autonomous vehicle model is shown. Block 202 trains a NeRF model to generate a 3D environment based on a 2D image input. This training may be based on both video information and LiDAR information, which are used to inform an RGB loss and a depth loss respectively. Block 204 then simulates scenarios using the trained NeRF model.

Thus the training data may include original data with RGB video frames, camera poses, LiDAR information, object trajectories, and timestamps associated with each frame. This original data is used in block 202 to train the NeRF model. A second category of training data is generated in block 204 using the trained NeRF model and includes new poses, timestamps, and object trajectories.

During NeRF training 202, object trajectories and timestamps define the state of dynamic objects in the NeRF. When combined with camera pose information, they enable the generation of RGB and depth images that adhere to the same specifications as the input RGB frames and LiDAR information. The NERF may be trained by minimizing the distance between the generated data and the original data.

Accurate prediction of geometric information is needed to generate photorealistic images, particularly when shifting to novel perspectives. For example, if the road geometry is encoded inaccurately as a non-flat surface, this can result in discontinuity of lane lines in a simulated scenario that takes a new perspective in the same environment. The depth loss used during training 202 is therefore included to ensure that the geometric information is correct.

The loss used for training the NeRF model may therefore include an expected depth loss and a sampling distribution loss in addition to an RGB loss:

$$ℒ = {ℒ}_{RGB} + {αℒ}_{depth} + {βℒ}_{dist}$$

where α and β are weighting hyperparameters. The RGB loss may be implemented as a mean-squared error between a rendered image and an input video. For the expected depth loss, the expected depth may be regularized to be close with the depth information of the original LiDAR input. Specifically, the expected depth is computed as:

$$\hat{z} = {\int }_{{t}_{n}}^{{t}_{f}} w ( t ) \cdot tdt$$

where tₙ and t_{f} stand for the sampling distances for the nearest and farthest sampling points, respectively, and w(t) represents the weight at distance t. The expected depth loss for a given LiDAR input θ is determined as:

$${ℒ}_{depth} ( θ ) = {E}_{r \sim 𝔻} [ {( \hat{z} - z )}^{2} ]$$

where z is the depth given by the LiDAR. The term r is a camera ray sampled from ray distribution [symbol] .

The sampling distribution loss comes from line-of-sight priors from urban field NeRF. It assumes that the point measured by the LiDAR information corresponds to non-transparent surfaces and that the atmospheric medium does not contribute to the rendered color. In this case, the weight distribution should resemble a continuous Dirac function, peaking at z. However, enforcing exact similarity to the Dirac function is not numerically tractable. Therefore the target distribution may be relaxed to be a Gaussian distribution:

$${𝒦}_{ϵ} ( x ) = 𝒩 ( z , {( \frac{ϵ}{3} )}^{2} )$$

where z is the depth given by the LiDAR and ϵ is a small constant. The distribution loss can then be formalized as:

$${ℒ}_{dist} ( θ ) = {\int }_{{t}_{n}}^{{t}_{f}} {( w ( t ) - {𝒦}_{ϵ} ( t ) )}^{2} dt$$

Given that w(t) is discrete in practice, the loss may be discretized to:

$${ℒ}_{dist} ( θ ) = {\sum }_{t = {t}_{0}}^{{t}_{N}} {( w ( t ) Δ t - {\int }_{{t}_{n}}^{{t}_{f}} {𝒦}_{ϵ} dt )}^{2}$$

where t₀, . . . , t_{N} are N sampled points for computing w(t), Δt stands for the interval between two sampled points, and w(t) Δt is the weight at the current interval.

This loss function can guide the sampling in large-scale traffic scenes. When sampling misses a target interval [z−ϵ,z+ϵ], the loss regularizes the closest part after the interval to be high, thereby guiding the NeRF to sample more densely around the target region.

Additional criteria are applied to generate photorealistic samples during the simulation of block 204. Block 204 applies these criteria to guide the sampling of positions and poses within a given 3D scenario generated from an original 2D scenario input. A first criterion is that the novel view poses should stay near the original trajectory. While the depth loss effectively captures correct geometrical information, it struggles to accurately generate unseen regions. Moving far from the original trajectory exposes those regions, so keeping the new pose close to the original trajectory keeps the scenario in a territory that can be reasonably predicted.

A second criterion is to maintain the generated novel relative view direction and distance closely aligned with the existing relative view direction and distance to each moving vehicle seen in the original video. NeRF can generate high-quality content when similar views of vehicles exist in the input video, but quality can decrease when unseen surfaces of a vehicle are exposed or the distance changes significantly, such as when the camera moves from far to near.

The distance between the new and original poses, including both direction and position, can be determined to ensure that the differences remain within a predetermined range. For each new pose, the pose with a nearest original position can be identified to serve as a reference point. The difference sin position and viewing direction between the new and original poses can then be determined and can be constrained to fall within threshold values. The Euclidean distance and angular difference may be used to measure the differences.

For each moving vehicle in a scenario, the rendering process may be sensitive to changes in relative viewing direction. Thus for every new post, the original pose that has the closest relative view direction is identified as a reference. The relative differences in both position and viewing direction between the new and reference poses are determined to ensure that they stay within a specified range.

After one or more simulated scenarios are generated, block 206 uses these scenarios to train a model for an autonomous vehicle 102. For example, the training may use imitation learning to provide a set of realistic scenarios that may inform a policy, which an agent may subsequently use to select actions based on their present circumstances. Block 208 deploys the trained model, for example including parameters of a trained policy, to a target, such as the autonomous driving system of an autonomous vehicle.

During operation, block 210 collects new scene information, for example using on-board sensors and cameras of the autonomous vehicle. Based on the new scene information, block 212 selects and performs a driving action. For example, given the new scene information, the trained policy may indicate a particular driving action. Such a driving action may include, e.g., a steering action, an acceleration action, or a braking action.

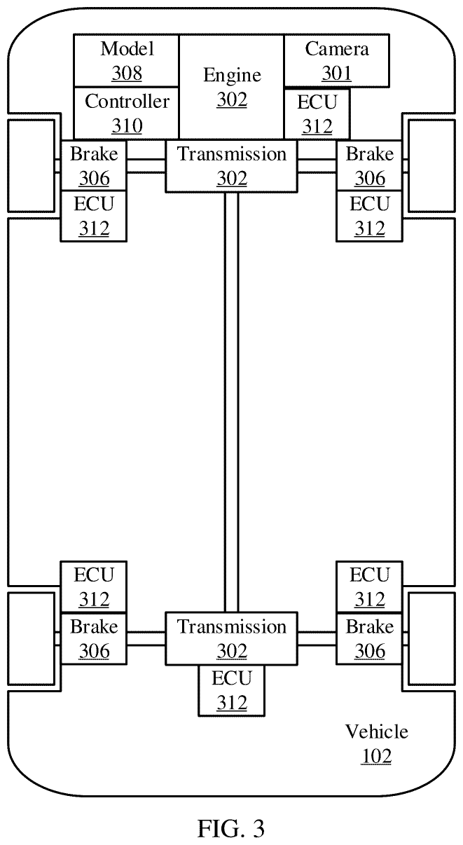

Referring now to FIG. 3, additional detail on a vehicle 102 is shown. A number of different sub-systems of the vehicle 102 are shown, including an engine 302, a transmission 304, and brakes 306. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 312, which perform measurements of the state of the respective sub-system. For example, ECUs 312 relating to the brakes 306 may control an amount of pressure that is applied by the brakes 306. An ECU 312 associated with the wheels may further control the direction of the wheels. The information that is gathered by the ECUs 312 is supplied to the controller 310. A camera 301 or other sensor (e.g., LiDAR or RADAR) can be used to collect information about the surrounding road scene, and such information may also be supplied to the controller 310.

Communications between ECUs 312 and the sub-systems of the vehicle 102 may be conveyed by any appropriate wired or wireless communications medium and protocol. For example, a car area network (CAN) may be used for communication. The time series information may be communicated from the ECUs 312 to the controller 310, and instructions from the controller 310 may be communicated to the respective sub-systems of the vehicle 302.

Information from the camera 301 and other sensors is provided to the model 308, which may select an appropriate action to take. The controller 310 uses the output of the model 308, based on information collected from cameras 301, to perform a driving action responsive to the present state of the scene. Because the model 308 has been trained on diverse simulated inputs, it will determine a safe and efficient path to its destination.

The controller 310 may communicate internally to the sub-systems of the vehicle 302 and the ECUs 312. Based on detected road fault information, the controller 310 may communicate instructions to the ECUs 312 to avoid a hazardous road condition. For example, the controller 310 may automatically trigger the brakes 306 to slow down the vehicle 302 and may furthermore provide steering information to the wheels to cause the vehicle 302 to move around a hazard.

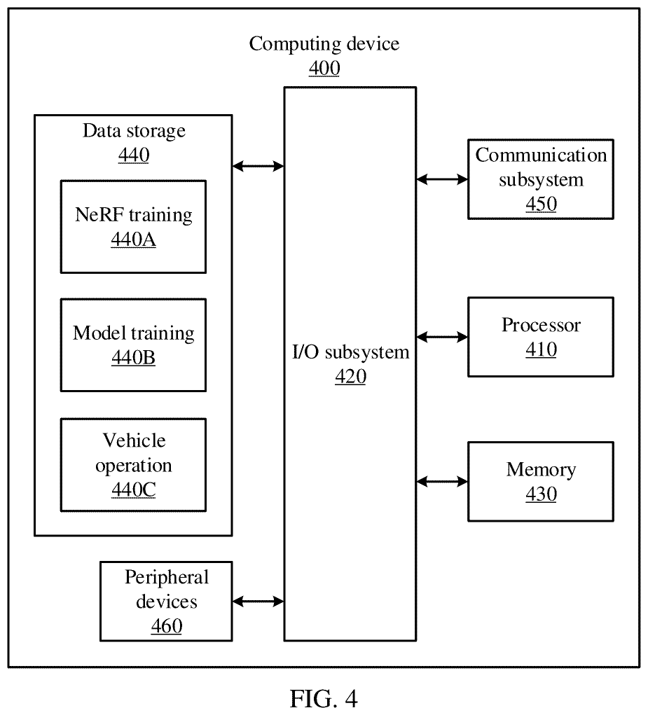

Referring now to FIG. 4, an exemplary computing device 400 is shown, in accordance with an embodiment of the present invention. The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for NeRF training, 440B for training a self-driving model, and/or 440C for performing vehicle operation actions using the trained planner model. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

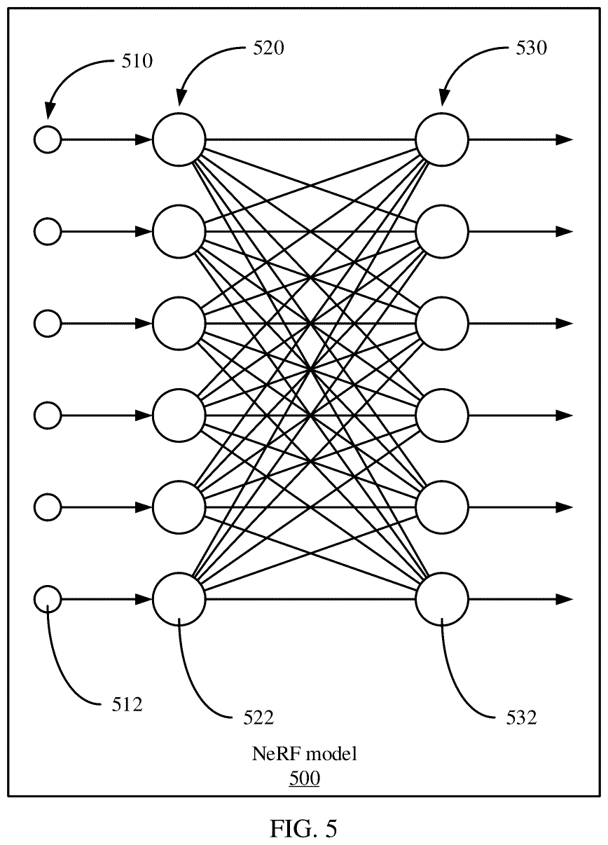

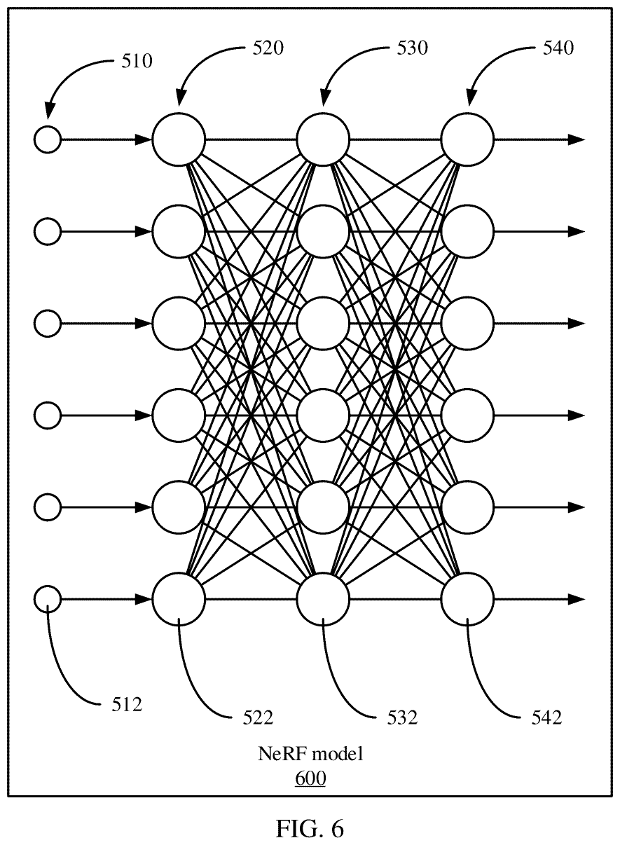

Referring now to FIGS. 5 and 6, exemplary neural network architectures are shown, which may be used to implement parts of the present models, such as the NeRF model 500/600. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and β and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
training a model for rendering a three-dimensional volume using a loss function that includes a depth loss term and a distribution loss term that regularize an output of the model to produce realistic scenarios;
generating a simulated scenario based on an original scenario, with the simulated scenario including a different position and pose relative to the original scenario in a three-dimensional (3D) scene that is generated by the model from the original scenario; and
training a self-driving model for an autonomous vehicle using the simulated scenario.

2. The method of claim 1, wherein generating the simulated scenario includes applying a criterion to limit a distance between a relative view direction and distance of the simulated scenario and a relative view direction and distance of the original scenario.

3. The method of claim 1, wherein generating the simulated scenario includes applying a criterion to limit a distance between the position of the simulated scenario and a position of the original scenario.

4. The method of claim 1, wherein the depth loss term is
$${ℒ}_{depth} ( θ ) = {E}_{r \sim 𝔻} [ {( \hat{z} - z )}^{2} ]$$
where E_{r˜D} is an expected value for a ray sampled from ray distribution [symbol] , \hat{z} is an expected depth, and z is a depth from a training sample.

5. The method of claim 1, wherein the distribution loss term is
$${ℒ}_{dist} ( θ ) = {\sum }_{t = {t}_{0}}^{{t}_{N}} {( w ( t ) Δ t - {\int }_{{t}_{n}}^{{t}_{f}} {𝒦}_{ϵ} dt )}^{2}$$
where t₀, . . . , t_{N} are N sampled points for computing, w(t) represents a weight at distance t, Δt stands for an interval between two sampled points, tₙ and t_{f} stand for sampling distances for nearest and farthest sampling points, respectively, and [symbol] _{ϵ} is a target distribution.

6. The method of claim 1, wherein the loss function further has an RGB (red-green-blue) term implemented as a mean-squared error loss between a rendered image and a training sample.

7. The method of claim 1, wherein training the self-driving model includes imitation learning of a policy using the simulated scenario and the original scenario as examples.

8. The method of claim 1, further comprising sensing information about a new scenario and performing a driving action based on an output of the self-driving model responsive to the scenario.

9. The method of claim 8, wherein the information about the new scenario includes new video and LiDAR information.

10. The method of claim 8, wherein the driving action is selected from the group consisting of a steering action, an acceleration action, and a braking action.

11. A system, comprising:
a hardware processor; and
a memory that stores a computer program which, when executed by the hardware processor, causes the hardware processor to:
train a model for rendering a three-dimensional volume using a loss function that includes a depth loss term and a distribution loss term that regularize an output of the model to produce realistic scenarios;
generate a simulated scenario based on an original scenario, with the simulated scenario including a different position and pose relative to the original scenario in a three-dimensional (3D) scene that is generated by the model from the original scenario; and
train a self-driving model for an autonomous vehicle using the simulated scenario.

12. The system of claim 11, wherein the generation of the simulated scenario includes applying a criterion to limit a distance between a relative view direction and distance of the simulated scenario and a relative view direction and distance of the original scenario.

13. The system of claim 11, wherein the generation of the simulated scenario includes applying a criterion to limit a distance between the position of the simulated scenario and a position of the original scenario.

14. The system of claim 11, wherein the depth loss term is
$${ℒ}_{depth} ( θ ) = {E}_{r \sim 𝔻} [ {( \hat{z} - z )}^{2} ]$$
where E_{r˜D} is an expected value for a ray sampled from ray distribution [symbol] , \hat{z} is an expected depth, and z is a depth from a training sample.

15. The system of claim 11, wherein the distribution loss term is
$${ℒ}_{dist} ( θ ) = {\sum }_{t = {t}_{0}}^{{t}_{N}} {( w ( t ) Δ t - {\int }_{{t}_{n}}^{{t}_{f}} {𝒦}_{ϵ} dt )}^{2}$$
where t₀, . . . , t_{N} are N sampled points for computing, w(t) at represents a weight at a distance t, Δt stands for an interval between two sampled points, tₙ and t_{f} stand for sampling distances for nearest and farthest sampling points, respectively, and [symbol] _{ϵ} is a target distribution.

16. The system of claim 11, wherein the loss function further has an RGB (red-green-blue) term implemented as a mean-squared error loss between a rendered image and a training sample.

17. The system of claim 11, wherein the training of the self-driving model includes imitation learning of a policy using the simulated scenario and the original scenario as examples.

18. The system of claim 11, wherein the computer program further causes the hardware processor to sense information about a new scenario and to perform a driving action based on an output of the self-driving model responsive to the scenario.

19. The system of claim 18, wherein the driving action is selected from the group consisting of a steering action, an acceleration action, and a braking action.

20. A non-transitory computer readable storage medium that stores a computer program which, when executed by a computer, causes the computer to:
train a model for rendering a three-dimensional volume using a loss function that includes a depth loss term and a distribution loss term that regularize an output of the model to produce realistic scenarios;
generate a simulated scenario based on an original scenario, with the simulated scenario including a different position and pose relative to the original scenario in a three-dimensional (3D) scene that is generated by the model from the original scenario; and
train a self-driving model for an autonomous vehicle using the simulated scenario.
